(19) United States
(12) Patent Application Publication
(10) Pub. No.: US 2026/0148067 A1
(43) Pub. Date: May 28, 2026

(54) AUTOMATIC FEATURE PRUNING USING A MACHINE LEARNING TEACHER NETWORK

(71) Applicant: Robert Bosch GmbH, Stuttgart (DE)

(72) Inventors: Thomas ROCZNIK, Mountain View, CA (US); Zubin ABRAHAM, Sunnyvale, CA (US); Christian PETERS, Mountain View, CA (US); Nima AGHLI, Milpitas, CA (US); Ken WOJCIECHOWSKI, Cupertino, CA (US)

(21) Appl. No.: 18/960,484

(22) Filed: Nov. 26, 2024

(51) Int. Cl. G06N 3/082; G06N 3/042; G06N 3/045

(52) U.S. Cl. CPC G06N 3/082; G06N 3/042; G06N 3/045

(57) ABSTRACT

A method and system for data classification in a multi-stage neural network system by obtaining a first physical activity sensed by the sensor and initiating a first-stage neural network trained using a subset of a dataset. The first neural network classifies the operating state of the first physical activity. A second-stage neural network, trained using the full dataset, is initiated when the first-stage neural network classifies the operating state of the first physical activity as not active. The second-stage neural network identifies features from a feature map that prevented the first-stage neural network from classifying the first activity and prunes these features. The system then obtains a second physical activity from the sensor and re-initiates the first-stage neural network to classify this second activity.

### TECHNICAL FIELD

The following relates generally to a system and method of training and deploying a multi-stage teacher neural network.

### BACKGROUND

Convolutional neural network (CNN) is a class of deep, feed-forward artificial neural networks, most commonly applied to many different applications that include computer vision and speech recognition. Prior CNN models are typically executed on a single entity, e.g., a dedicated graphical processing unit (GPU) or neuronal network accelerator that do not process multiple different tasks together.

### SUMMARY

A system for data classification in a multi-stage neural network system comprises at least one sensor operable to sense physical activities, and a memory connected to a processor. The memory stores instructions executed by the processor, which is configured to obtain a first physical activity sensed by the sensor and initiate a first-stage neural network trained using a subset of a dataset. This first neural network classifies the operating state of the first physical activity. A second-stage neural network, trained using the full dataset, is initiated only when the first-stage neural network classifies the operating state of the first physical activity as not active. The second-stage neural network identifies features from a feature map that prevented the first-stage neural network from classifying the first activity and prunes these features. The system then obtains a second physical activity from the sensor and re-initiates the first-stage neural network to classify this second activity.

The system further allows the second-stage neural network to modify features when the first-stage neural network incorrectly classifies the operating state of the first physical activity a predetermined number of times. These modifications can involve assigning a constant value to the features or randomly modifying them until the first-stage neural network correctly classifies the operating state. The system may include a remote server in communication with the processor, where modified features are transmitted to the server, combined with stored features to generate a set of combined features, and retransmitted to the processor for use by both neural networks.

The first-stage neural network may include multiple convolutional kernels, and the second-stage neural network can replace the output of at least one of these kernels. But it should be understood that the type of neural network is not limited to a specific type. Instead, the neural network which may be employed could include, but are not limited to, convolutional neural networks (CNNs), recurrent neural networks (RNNs), feedforward neural networks, long short-term memory networks, modular neural networks, multilayer perception (MLP) generative adversarial networks, or bidirectional recurrent neural networks (BRNNs). Outputs from the convolutional kernels may be processed through an activation function, such as a rectified linear unit activation function. The first-stage neural network is designed to require less energy and computational power than the second-stage neural network. Additionally, the second-stage neural network employs a set of second features stored in memory to extract features used by the first-stage neural network.

### BRIEF DESCRIPTION OF THE DRAWINGS

FIG. 1 depicts an exemplary computing system.

FIG. 2 illustrates an exemplary machine learning convolutional neural network (CNN).

FIG. 3 illustrates a flow diagram of the multi-stage teacher neural network.

FIG. 4 illustrates a block diagram of the first stage network for the multi-stage teacher neural network.

FIG. 5 illustrates a block diagram of the data dimensions for each layer of the first stage network.

### DETAILED DESCRIPTION

Embodiments of the present disclosure are described herein. It is to be understood, however, that the disclosed embodiments are merely examples and other embodiments may take various and alternative forms. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

It is contemplated that artificial intelligence or machine learning algorithms (AI/ML) may comprise neural network model comprising billions of parameters. The extensive number of parameters may be needed in order to allow a model to perform various tasks - e.g., image recognition. But large models require large amounts of memory space and increased computational power.

Given the increased usage of AI/ML models, there has been an increased need for reducing the size of a model without a degradation in accuracy. It is contemplated one method of compressing a model may involve “pruning” that seeks to remove parameters from a network (e.g., redundant parameters); a specified portion of the model; or a specified search space. It is also contemplated that pruning may be desirable as it may provide regularization to prevent overfitting. Or pruning may provide smaller versions of a model with marginal depreciation in performance or operation. Lastly, pruning may reduce computational complexity and inference time. In short, pruning can reduce a significant number of parameters from the model thereby reducing the storage requirements and improving the computation efficiency of neural networks.

The present disclosure contemplates employing an automatic feature pruning in a “teacher” AI/ML network that comprises at least two stages (i.e., a first stage network and a second stage network) with each stage having different computational capacity. A smaller first stage network may be employed to make a given or predetermined decision and/or classification. This first stage network may be trained (as discussed below) using a complete or full dataset.

Next, a larger, more capable second stage network may be trained using the same dataset employed to train the first stage network. The same dataset may be employed because the first stage network may not be operable to capture all information from the dataset given it is not as large as the second stage network. However, the second stage network may be operable to employ the full dataset given it may include one or more layers of feature extractors (e.g., convolutional kernels). However, it is also contemplated that multiple additional stages may also be included (i.e., fourth stage network, etc.) depending on the application. This additional stages may work in parallel with the second stage network or independent. The first stage network may deploy each additional stage depending on the configuration or classification being handled.

The second stage network may be operable to make classification with higher accuracy and confidence than the first stage network. As such, when or if the first stage network is not capable of providing a clear classification, the first stage network may request or employ the second stage network as the “teacher” to provide an answer. It is contemplated that when the second stage is employed to provide an answer, the second stage may also actively prune out features from the first stage network to improve the confidence and the accuracy of the first stage network. For instance, it is contemplated that for a running application the pruning operation may classify the running style of the user. However, when the user is a borderline case, the second stage network may attempt to identify the feature(s) that prevents the first stage network from classifying the correct activity. In this instance, the second stage network may prune these features from the first stage network. It is contemplated that such pruning by the second stage network may be done using a brute force search given the size of the first stage network.

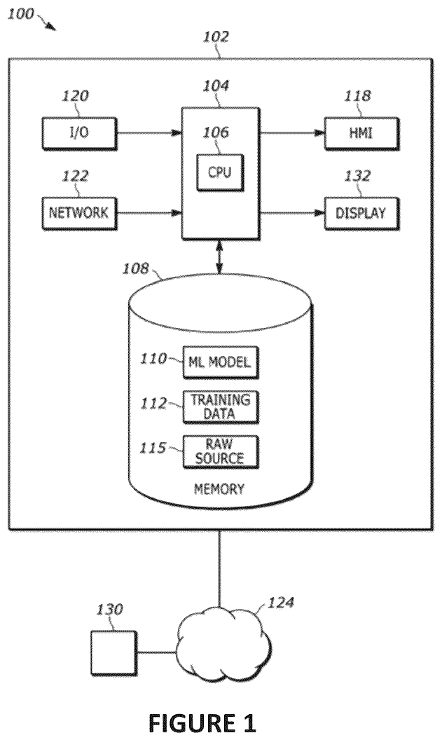

FIG. 1 illustrates an exemplary system 100 that may be used for employing the multi-stage teacher network. The system 100 may include at least one computing devices 102. The computing system 102 may include at least one processor 104 that is operatively connected to a memory unit 108. The processor 104 may be one or more integrated circuits that implement the functionality of a central processing unit (CPU) 106. The CPU 106 may be a commercially available processing unit that implements an instruction stet such as one of the x86, ARM, Power, or MIPS instruction set families.

During operation, the CPU 106 may execute stored program instructions that are retrieved from the memory unit 108. The stored program instructions may include software that controls operation of the CPU 106 to perform the operation described herein. In some examples, the processor 104 may be a system on a chip (SoC) that integrates functionality of the CPU 106, the memory unit 108, a network interface, and input/output interfaces into a single integrated device. The computing system 102 may implement an operating system for managing various aspects of the operation.

The memory unit 108 may include volatile memory and non-volatile memory for storing instructions and data. The non-volatile memory may include solid-state memories, such as NAND flash memory, magnetic and optical storage media, or any other suitable data storage device that retains data when the computing system 102 is deactivated or loses electrical power. The volatile memory may include static and dynamic random-access memory (RAM) that stores program instructions and data. For example, the memory unit 108 may store a machine-learning model 110 or algorithm, training dataset 112 for the machine-learning model 110, and/or raw source data 115.

It is further contemplated that processor 104 or CPU 106 can include any existing programmable electronic control unit or dedicated electronic control unit. The processes, methods, or algorithms described within can also be stored as data, logic, and instructions executable by the processor 104/CPU 106 in many forms including, but not limited to, information permanently stored on non-writable storage media or in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The computing system 102 may include a network interface device 122 that is configured to provide communication with external systems and devices. For example, the network interface device 122 may include a wired and/or wireless Ethernet interface as defined by Institute of Electrical and Electronics Engineers (IEEE) 802.11 family of standards. The network interface device 122 may include a cellular communication interface for communicating with a cellular network (e.g., 3G, 4G, 5G). The network interface device 122 may be further configured to provide a communication interface to an external network or cloud.

The external network 124 may be referred to as the world-wide web or the Internet. The external network 124 may establish a standard communication protocol between computing devices. The external network 124 may allow information and data to be easily exchanged between computing devices and networks. One or more servers 130 may be in communication with the external network 124.

The computing system 102 may include an input/output (I/O) interface 120 that may be configured to provide digital and/or analog inputs and outputs. The I/O interface 120 may include additional serial interfaces for communicating with external devices. For instance, the I/O interface 120 may be configured to receive data from sensors that provide sensed signals. The sensors employed may include video (camera or vision systems), radar, LiDAR, ultrasonic, motion, or thermal sensor that provides sensed signals relating to digital images. Or the sensors may be radar or LIDAR that provide sensed signals relating to digital point cloud data.

The sensor systems may be used by system 100 to classify the sensor data and detect the presence of objects in the sensor data or perform a semantic segmentation on the sensor data. For instance, system 100 may use the sensed data to detect objects like traffic signs, pedestrians, vehicles or other objects which may appear when a vehicle is being operated in a real-world environment. It is contemplated system 100 may operate to carry out such functions based on low-level features like edges, point-cloud data, or pixel attributes within a digital image or digital point cloud data.

The computing system 102 may include a human-machine interface (HMI) device 118 that may include any device that enables the system 100 to receive control input. Examples of input devices may include human interface inputs such as keyboards, mice, touchscreens, voice input devices, and other similar devices. The computing system 102 may include a display device 132. The computing system 102 may include hardware and software for outputting graphics and text information to the display device 132. The display device 132 may include an electronic display screen, projector, printer or other suitable device for displaying information to a user or operator. The computing system 102 may be further configured to allow interaction with remote HMI and remote display devices via the network interface device 122.

The system 100 may be implemented using one or multiple computing systems. While the example depicts a single computing system 102 that implements all of the described features, it is intended that various features and functions may be separated and implemented by multiple computing units in communication with one another. The particular system architecture selected may depend on a variety of factors.

The system 100 may implement a machine-learning algorithm 110 (i.e., AI/ML) that is configured to analyze the raw source data 115 (or dataset). The raw source data 115 may include raw or unprocessed sensor data that may be representative of an input dataset for a machine-learning system. The raw source data 115 may include video, video segments, images, and raw or partially processed sensor data (e.g., data from digital camera or LiDAR sensor). In some examples, the machine-learning algorithm 110 may be a neural network algorithm (i.e., CNN or DNN) that may be designed to perform a predetermined function.

The system 100 may store a training dataset 112 for the machine-learning algorithm 110. The training dataset 112 may represent a set of previously constructed data for training the machine-learning algorithm 110. This training dataset 112 may be the data for a given encoder that was trained using the foundation model.

The training dataset 112 may be used by a machine-learning algorithm 110 to learn weighting factors associated with a neural network algorithm. The training dataset 112 may include a set of source data that has corresponding outcomes or results that the machine-learning algorithm 110 tries to duplicate via the learning process. For instance, the training dataset 112 may include source images and depth maps from various scenarios in which objects (e.g., pedestrians) may be identified.

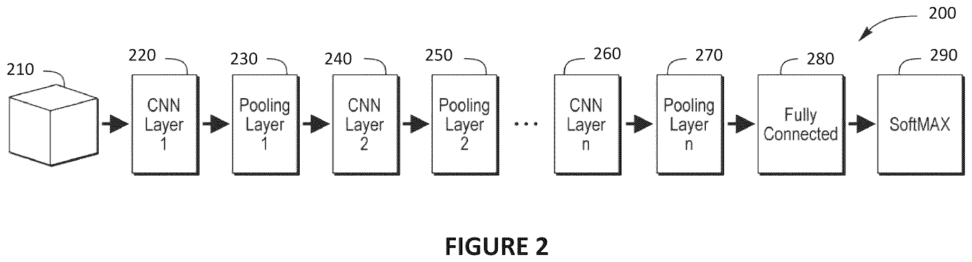

FIG. 2 illustrates an exemplary neural network or CNN 200 that may employed using system 100. It is contemplated CNN 200 may be representative of any stage of the multi-stage teacher network. However, it is also contemplated the size and structure of CNN 200 may differ depending on the given stage (e.g., first stage network, second stage network, etc.) or the application being employed. It is also contemplated network 200 may alternatively be designed using a Dense Neural Network, Recurrent Neural Networks, Feed Forward Networks, or Modular Neural Networks. Depending on the application, CNN 200 may also be varied to have a different structure and layer than shown and described.

Exemplary CNN 200 may include one or more convolutional layers 220-240; one or more pooling layers 250-270; a fully connected layer 260; and a softmax layer 270. The input data 210 provided to CNN 200 may be raw image data, voice data, or text data. Input data 210 may also include measurements received from sensor readings. Alternatively, input data 210 may be lightly processed prior to being provided to CNN 200. Convolutional layers 220-240 may be operable to extract features from input data 210. Convolutional layer 220-240 generally applies filtering operations (e.g., kernels) before passing on the result to the next layer of the CNN 200. For instance, convolutional layer 220-240 may apply a filter over the image, scanning a few pixels for input data 210 that is a raw image, creating a feature map that may be used to predict a class to which each feature may belong.

The CNN may also include one or more pooling layers 250-270 that receives the feature map from the one or more convolution layer 220-240. Pooling layers 250-270 may include one or more pooling layer units that apply a pooling function to one or more features (or feature maps) computed at different bands using a pooling function. For instance, pooling layer 250 may apply a pooling function to the feature map received from convolutional layer 220. The pooling function implemented by pooling layers 250-270 may be an average or a maximum function or any other function that aggregates multiple values into a single value. It is contemplated that the pooling layers 250-270 may operate to reduce the amount of information in each feature (or feature map) obtained from the convolutional layers 220-240 while attempting to maintain information that may be pertinent.

Next, a fully connected layer 280 may attempt to learn non-linear combinations for the high-level features which are the outputs received from the convolutional layers 220-240 and pooling layers 250-270. For instance, the fully connected layer 280 may operate on the output of the convolutional layers 220-240 and pooling layers 250-270 (which may represent the activation maps of high-level features) and the fully connected layer 280 may then determine which features correlate to a particular class. Lastly, CNN 200 may include a softmax layer 290 that combines the outputs of the fully connected layer 280 using softmax functions.

Models like CNN 200 typically require high energy consumption, memory storage, and calculation/computational power. CNN 200 may typically be executed on system 100 as described above and such system may include a dedicated microcontroller, special hardware (e.g., neuronal network accelerator) or graphic processing unit (GPU).

Again, it is understood that CNN 200 is just representative, and that the shown input layer 210 and layers 220-290 may include one or more convolutional layers, pooling layers, fully connected layers and a softmax functions like those described with respect to CNN 200. It is also understood that a trained classifier, like CNN 200, may only be as good as it is able to generalize from a given training set. Generalization may require a diverse dataset and a classification algorithm that is able to contain the information while not allowing overfitting.

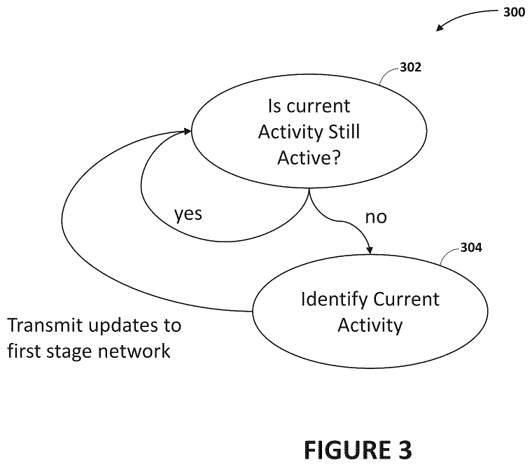

FIG. 3 illustrates a flow diagram for the multi-stage teacher classifier 300 having a first stage 302 and a second stage 304. Again, the first stage 302 or second stage 304 may be a convolutional neural network like that discussed with respect to CNN 200. But it is contemplated the first stage 302 may not include as many layers and may therefore may not be as complex as the second stage 304.

As further shown, classifier 300 may be operable to make classifications of a current state or condition using both the first stage 302 and the second stage 304. The first stage 302 may be a binary classifier that has been optimized for power consumption and memory storage. As such, the first stage 302 may be operable to determine if a current state/condition is still ongoing.

For instance, classifier 300 may be designed to classify a given human activity. The human activity may be related to the monitoring of a specified movement/non-movement (e.g., speed of movement, intensity of movement, duration of movement, walking/running movement, sitting/standing, sleeping) or biomechanical activity (e.g., heart rate, blood pressure). The monitored human activity may be done using one or more sensors like accelerometers, gyroscopes, magnetometers, ultrasound, optical, EMG, force sensors, cameras, Lidar, radar or the like. It is contemplated that sensors may provide sensed signals to processor 104 via the I/O 120. It is further contemplated the sensed signals Classifier 300 may be used to interpret and classify the sensed data received from the sensors.

Classification of human activity may be employed on devices where system memory is limited and high-power consumption is not desirable. For instance, the classification may occur on edge devices like smartphones (e.g., iPhone or Android), tablets (e.g., iPad), IoT sensors and controllers. It is contemplated the classification may be designed to operate on IoT devices like smart doorbells/cameras (e.g., Ring and Google home), autonomous and connected vehicles, robotic devices, or smart lighting systems (e.g., traffic lights, outdoor lighting, indoor lighting). But such systems are merely exemplary, and the multi-stage teacher classifier 300 may be employed on any number of other systems.

The first stage 302 may be designed to operate within memory of a device to classify whether the human activity being monitored is still occurring. If, for instance, the first stage 302 determines the monitored behavior has stopped, the first stage 302 may report the user is no longer walking. When operating on a smartwatch, the first stage may be employed to determine if a user is walking. If the user begins running or simply stops walking, the first stage 302 may determine the user is no longer walking.

While the first stage 302 may report that the user is no longer walking, the first stage 302 may not be operable to classify the new activity. It is contemplated the first stage 302 would operate in this manner as it would provide a binary classification (e.g., 1=walking, 0=not walking). So in the above example, when the user begins running or simply stops walking, the first stage 302 would simply change state from “1” to “0” thereby indicating the state has changed. If the first stage 302, determines the activity is still going (e.g., walking), then the first stage 302 continues to classify the activity. However, if the first stage 302 determines the activity being monitored is no longer occurring (e.g., not walking), the second stage 304 is activated.

It is contemplated the second stage 304 may also be located on the same device as the first stage 302. However, it is also contemplated that the second stage 304 may be larger than the first stage 302. In other words, the second stage 304 may include more layers of feature extractors (e.g., convolutional kernels).

It is contemplated both the first stage network and second stage network may reside in memory (e.g., memory 108) of the same system (e.g., system 102). It is also contemplated the second stage 304 may be located on a device remote from the first stage 302. The second stage 304 may, for instance, be located on a remote computing device (e.g., laptop or server) like server 130 which could include more memory and computational power than the device (e.g., system 102) upon which the first stage 302 may be located. A communication link between the first stage 302 and second stage 304 would therefore be required. For instance, the network interface device 122 may be configured to provide a communication interface between the first stage 302 and second stage 304.

Lastly, it is contemplated the first stage 302 and second stage 304 may be implemented within separate cores of the same processor or controller (e.g., processor 104 or CPU 106). Again, the first stage 302 is designed to operate on less memory and consume less power than the second stage 304. As such, it is contemplated a portion of a processors core can be used to employ the first stage 302 and either a separate or expanded portion of the processor's core may be used when the second stage 304 is employed.

It is further contemplated that the first stage 302 and the second stage 304 may be operated using portions of a common neural network. For instance, CNN 200 may be employed by both the first stage 302 and the second stage 304. But the first stage may operate using just a portion of the layers or functions shown. For instance, the first stage 302 may only operate using layer 220 (or even a subset of this layer). It is contemplated that the first stage 302 may only operate using a portion of the layer to reduce the amount of memory, processing power, and energy needed to perform the binary classification. When required, the second stage 304 may operate using a larger extent of the layers shown by CNN 200 to do the more complex classification. By disabling the neural network layers/functions used when operating either the first stage 302 or second stage 304, the classifier 300 may operate on devices that have limited processing power, memory, and battery like the edge devices discussed above.

With reference back to FIG. 3, the second stage 304 may be a multiclass classifier. As shown the second stage 304 may operate to identify or provide classification for a given activity. For instance, the second stage 304 may be operable to determine the current activity (state) from a set of activities (states) with high confidence. Once a new activity has been determined by the second stage 304, a new binary classification (e.g., running=“1” or running=“0”) that is optimized for classification of the new activity (e.g., running) may be transmitted back to the first stage 302. This new binary classification may then replace the prior binary classification (e.g., running replaces walking).

In other words, the first stage 302 would be updated by the new binary classification. The update of the first stage network (i.e., CNN classifier like CNN 200) may include changes to the weights or structure of the classifier. Once updated, the new first stage network would take over observation of the new state (i.e., condition or activity).

It is contemplated the state (e.g., activity) should not be changed frequently. In other words, the first stage 302 should not be toggling and transmitting control to the second stage 304 on frequent basis. For instance, the first stage 302 should monitor that the user is not doing the monitored activity (i.e., not “walking”) for a predetermined time period. Again, given the activity can be classified with a high confidence by the first stage 302, reduced memory and low energy consumption will be required in comparison to the activities performed by the second stage 304. The first stage 302 may therefore reduce the overall energy consumption of the classification system. In contrast, the second stage 304 which consumes more energy, should only be active when and if the first stage 302 fails to predict or classify the activity. The energy reduction of the first stage 302 can be achieved by implementing a smaller network (e.g., less layers) than the second stage 304.

It is contemplated the first stage 302 may incorrectly activate the second stage 304 due to a perceived change in state (i.e., activity). For instance, the first stage 302 may incorrectly register that a user is no longer walking, when in fact the user is still indeed walking. It would be undesirable during such incorrect classifications for the second stage 304 to perform a full reclassification where new weights or a new/altered neural network (e.g., a new CNN) is transmitted back to the first stage 302. As such it is contemplated the second stage 304 may also be designed to first perform a verification of the first stage 302 activity. In other words, the second stage 304 may confirm and override the first stage network 304 if an incorrect classification occurred. This would allow the first stage 302 to retain its prior configuration.

It is also contemplated that if the second stage 304 is being activated a predetermined number of times within a given timeframe, the current user or environment may not fall within the generalization of the trained first stage 302. For example, a given user may walk differently due to a change in conditions. This could occur when it a user is walking across an icy sidewalk requiring the user to walk more slowly during certain portions to reduce a slip and fall.

In such a scenario, the multi-stage teacher classifier 300 may wish to maintain high classification accuracy due to the correction of the first stage 302 misclassification by the second stage 304. But as explained above, elevated use of the second stage 304 to correct these inaccurate misclassifications is not desirable as it results in a significant increase in power consumption due to the operational size/complexity, storage requirements, and computational power of the second stage 304 in comparison to the first stage 302. Continual usage of the second stage 304 is therefore undesirable especially in applications where both the first stage 302 and second stage 304 are running on a device with limited computational power, memory, and battery power.

It is also contemplated that classifier 300 may be operable to adapt the classifier of the first stage 302 to a given user by adapting one or more features until the corresponding output fits or conforms to the output provided by the second stage 304. Such an adaptation may be desirable because one or several features may not generate the correct output due to the user falling outside the generalization of the first stage 302. Classifier 300 may therefore adapt or replace certain features of the first stage 302 with constant values that will allow the first stage 302 the ability to satisfy and correctly classify the condition. It is contemplated that a threshold may be used to detect the conditions where the first stage 302 may fail to classify the state correctly. For instance, the number of false positives may be counted within a predetermined time frame. If the number of false positives exceed a predefined threshold value this would start the feature map modification.

Classifier 300 may then include an overarching algorithm that feeds the false negative data samples along with true positive data into the first stage 302. Within the first stage 302, the algorithm may then begin to randomly enable or disable features by setting them to high (1) or low (0). As such, the algorithm may determine one or more features that have to be adapted in order to generate the correct output according to the second stage 304. For smaller networks, this can be done by brute force or a more systematic approach may be employed.

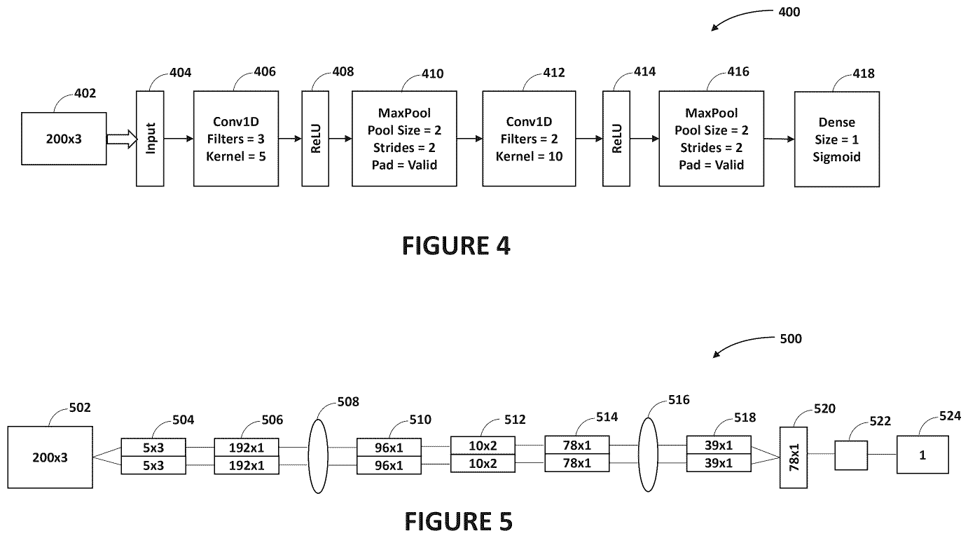

FIG. 4 represents an example network 400 that may be used as the first stage 302. FIG. 5 illustrates a block diagram 500 that is exemplary of the data dimension sizes of network 400. As shown, a 200×3 dimensional input dataset 402/502 may be provided as an input 404 to the network 400. The network 400 may include a first 1-dimensional convolutional kernel 406. The kernel 406 may be sized with a pair of filter masks 504 having a width x height of 5×3. The output after the ReLU activation function 408 may be a 192×2 matrix (as shown by 506) which may then be down sampled by a max pool layer 410 to a dimension of 96×2 (as shown by 510).

A pair of 1D convolutional kernels 412 may then be employed each having a dimension of 10×2 (as shown by 512). The output of kernels 412 may then be processed through another ReLU activation function 414 such that an output after the activation is a data dimension size of 78×2 (as shown by 514). Next, the data may be down sampled by max pool layer 416 to a data dimension having a size of 39×2 (as shown by 518 ).

This matrix may then be flattened to a data dimension size of a 78×1 vector (as shown by 520). Vector 520 may then be processed through a dense layer 418 (also shown as 522) such that the output serves as the input for a single fully connected node which ultimately provides a single binary output (as shown by 524).

It is contemplated that each trained convolutional kernel (e.g., 406 and 412) may capture a characteristic (feature) of the input signal which is later compared to the other extracted characteristics. The output of a convolutional layer may then be used to indicate the presence of the trained features in the current input sample. If the first stage 302 produces false negatives above a predefined threshold (which can be confirmed using the second stage 304) it is contemplated such results may be due to one or several characteristics not being satisfied and therefore failing to produce a positive output. However, given the output should be positive, classifier 300 may attempt to find out which characteristics failed and overwrite these characteristics.

Classifier 300 may also be designed to test a certain number of captures samples that produces a false negative, but we also need to ensure that true positives and true negative samples still produce the correct result after the modification. It is contemplated such a modification may be implemented in a variety of different manners. For instance, the output of a convolutional kernel (i.e., 406 or 412) may be replaced with a high or low value and it may then be tested with the collected samples. This approach may limit the number features that would need to be manipulated (e.g., 4 features). Alternatively, the classification could be done by the fully connected layer (i.e., 416 or 520). Specifically, network 400 could attempt to modify the flattened input layer 404 to the fully connected layer 416/520. This approach could result in 78 possible signals to modify which gives a significant higher degree of freedom but also results in more possibilities to try and therefore a higher computational effort.

Third, the output of the convolutional kernels (406/412) could be processed through activation functions like ReLU (e.g., 408/414). This modification can also provide a number of desired results. For instance, modifying the activation functions may be desired as it could be cheaper to perform since only “n” attempts for each layer with “n” convolutional kernels are needed.

Finally, it is possible to modify the weights of the convolutional kernels (406 or 412) directly to achieve the desired output. The modified parameters could be stored (e.g., in memory 108) and loaded to the first stage 302 if needed without repeating this procedure. Beside local storage in memory 108, the parameters can also be uploaded to the cloud (e.g., via network 124 to server 130) and combined with the information from other users to increase the robustness of the system including first stage 302 and second stage 304. It is contemplated it would be desirable to combine such data for use in applications like ride sharing or fleet learning.

It is also contemplated the described procedure can also be used to compensate for internal effects of the sensor system, e.g. aging of a sensor that is connected to I/O 120. The above example can be applied to other classifiers such as decision trees which allows for searching of one (or several) failing decisions and overwrites such decisions. In case an ensemble may be used (e.g. a random forest), trees can be weighted individually to change the overall outcome to the correct value. Finally, should the application always be used by the same user, the system 100 can store successful corrections (e.g., in memory 108) and the classifier 300 may then try such stored corrections first before using brute force searches. For instance, if a user starts performing an activity (e.g., running) and on some point the road starts to lean or tilt to the right which may cause confusion in classification by the first stage 302. Classifier 300 may, in such circumstances, try stored modification from the past first, in case we encountered this condition in the past, before going to a random search.

It is also contemplated to build a list of feature combinations that may trigger a certain classification right after training and build a small database. The stored list of features may also be used prior to implementing a brute force solution. In case an already modified first stage 302 produces false negatives, system 100 may also try the original version without modification first. It is possible that the condition that caused confusion by the first stage 302 may have been corrected or negated (e.g., user is no longer leaning or tilting) and first stage 302 may be receiving “normal” classifications regarding the users activity.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

As used herein, the term “and/or” means that either all or only one of the elements of said group may be present. For example, “A and/or B” means “only A, or only B, or both A and B”. In the case of “only A”, the term also covers the possibility that B is absent, i.e. “only A, but not B”. It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps. The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole. The phrase “consisting essentially of” limits the scope of a claim to the specified materials or steps, plus those that do not materially affect the basic and novel characteristic(s) of the claimed subject matter. The term “one or more” means “at least one” and the term “at least one” means “one or more.” The terms “one or more” and “at least one” include “plurality” as a subset.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for data classification in a multi-stage neural network system comprising:
at least one sensor operable to sense one or more physical activities;
a memory connected to a processor, the memory storing instructions that are executed by the processor, the processor being configured to:
obtain a first physical activity sensed by the at least one sensor;
initiate a first stage neural network trained using a subset of a dataset, the first neural network being configured to classify an operating state of the first physical activity;
a second stage neural network trained using the full dataset, the second stage neural network being initiated only when the first stage neural network classifies the operating state of the first physical activity as not active, wherein the second stage neural network identifies features from a feature map preventing the first stage neural network from classifying the first activity, and the second stage neural network pruning the features identified from the feature map used by the first stage neural network; and
obtain a second physical activity from the at least one sensor; and
re-initiate the first stage neural network to classify the second activity.

2. The system of claim 1, wherein the second stage neural network operates to modify at least one of the features when the first stage neural network incorrectly classifies the operating state of the first physical activity a predetermined number of times.

3. The system of claim 2, wherein the second stage neural network modifies the features with a constant value so that the first stage neural network correctly classifies the operating state of the first physical activity.

4. The system of claim 2, wherein the second stage neural network randomly modifies the features until the first stage neural network correctly classifies the operating state of the first physical activity.

5. The system of claim 1 further comprising: a remote server in operable communication with the processor, wherein the features that are modified are transmitted to the remote server, the remote server combining the features with stored features to generate a set of combined features, and the remote server re-transmitting the set of combined features to the processor for use by the first neural network and second neural network.

6. The system of claim 1, wherein the first stage neural network includes a plurality of convolutional kernels, and the second stage neural network operates to replace the output of at least one of the plurality of convolutional kernels.

7. The system of claim 6, wherein at least one output from the plurality of convolutional kernels is processed through an activation function.

8. The system of claim 7, wherein the activation function is a rectified linear unit activation function.

9. The system of claim 1, wherein the first stage neural network requires less energy and computational power than the second stage neural network.

10. The system of claim 1, where in the second stage neural network employs a set of second features stored within memory to extract at least one of the features used by the first stage neural network.

11. The system of claim 1, wherein the first stage neural network is a binary classifier.

12. The system of claim 1, wherein the first stage neural network and the second stage neural network are designed using a decision tree.

13. A method for data classification in a multi-stage neural network system comprising:
sensing at least one or more physical activities using one or more sensors;
obtaining a first physical activity sensed by the at least one sensor;
initiating a first stage neural network trained using a subset of a dataset, the first neural network being configured to classify an operating state of the first physical activity;
initiating a second stage neural network being initiated only when the first stage neural network classifies the operating state of the first physical activity as not active, wherein the second stage neural network identifies features from a feature map preventing the first stage neural network from classifying the first activity, and the second stage neural network pruning the features identified from the feature map used by the first stage neural network; and
obtaining a second physical activity from the at least one sensor; and
re-initiating the first stage neural network to classify the second activity.

14. The method of claim 13, further comprising: modifying at least one of the features when the first stage neural network incorrectly classifies the operating state of the first physical activity a predetermined number of times.

15. The method of claim 14, further comprising: modifying the features with a constant value so that the first stage neural network correctly classifies the operating state of the first physical activity.

16. The method of claim 14, further comprising: modifying the features until the first stage neural network correctly classifies the operating state of the first physical activity.

17. The method of claim 13, further comprising: replacing an output of at least one of a plurality of convolutional kernels employed by the first stage neural network.

18. The method of claim 13, further comprising: transmitting weights used by the convolutional kernel from a remote server.

19. The method of claim 13, further comprising: storing one or more feature combinations relating to an activity classification.

20. A non-transitory computer-readable medium storing instructions that, when executed by a computing device, cause the computing device to perform a method for data classification in a multi-stage neural network system, the method comprising:
training a first stage neural network to classify input data with a subset of features;
evaluating the classification performance of the first stage neural network;
activating a second stage neural network when the first stage neural network's performance does not meet a predefined threshold;
identifying, by the second stage neural network, features that are candidates for removal from the first stage neural network to improve performance; and
updating the first stage neural network based on the identification of features to optimize future data classification tasks.
